(19) United States
(12) Patent Application Publication
(10) Pub. No.: US 2006/0146434 A1
(43) Pub. Date: Jul. 6, 2006

(54) Verification system for magnetically-written data

(76) Inventor: Richard David Saunders, Berkshire (GB)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/536,499

(22) PCT Filed: Oct. 10, 2003
(86) PCT No.: PCT/GB03/04407

§ 371 Date: Oct. 28, 2005

(30) Foreign Application Priority Data
Nov. 26, 2002 (GB) 0227455.3

(51) Int. Cl. G11B 5/09

(52) U.S. Cl. 360/53

(57) ABSTRACT

A method of verifying the accuracy or authenticity of alphanumeric magnetic data on a document, wherein the configuration of a pictorial or graphic magnetic reference image in the document is made visible by bringing movable particulate magnetic material into proximity therewith such that the particulate magnetic material takes up a distribution corresponding to the magnetic field of the reference image; and the magnetic image configuration thus revealed is compared with the reference image to identify any significant disconformity suggesting past exposure of the document to a magnetic field capable of altering said magnetic data.

This invention relates to a verification system for magnetically written data.

International (PCT) Patent Application No. WO 01/92961A discloses a sheet material carrying a coating containing cavities in which electrically- and/or magnetically-activatable particles are located. The thus-coated sheet material is machine-writable and -readable in a similar manner to media such as audio or video tapes, and floppy and hard disks for use in computers. The magnetically-activatable particles disclosed in WO 01/92961A are of the same general kind as used in media as just referred to, and include chromium dioxide, iron oxide, polycrystalline nickel-cobalt alloys, cobalt-chromium or cobalt-samarium alloys, or barium-ferrite. The base sheet on which the particles are coated is typically a natural or synthetic paper.

Our PCT application PCT/GB2003/002162 describes a magnetically-activatable sheet product comprising a pair of laminated outer sheets at least one of which is provided with a pigment/binder primer coat on its inward facing surface, between which is a magnetic layer comprising magnetically-activatable particles in a binder matrix, the outer sheets having sufficient opacity to mask the appearance of the magnetic layer. PCT/GB2003/002148 describes a magnetically-activatable sheet product comprising a pair of laminated outer sheets between which is a magnetic layer comprising magnetically-activatable particles in a binder matrix, the outer sheets having sufficient opacity to mask the appearance of the magnetic layer; at least one of the outer sheets being provided on its outward facing surface with a coating which comprises either microcapsules containing a solution of at least one chromogenic material, or dispersed droplets containing at least one chromogenic material in a pressure-rupturable matrix, or a colour developer composition, or both microcapsules containing at least one chromogenic material and also a colour developer.

Such products are capable of carrying both visible (printed or written) information and magnetic information. There is a need for a simple and cheap security system for such products, so that it is readily possible to determine whether the magnetic information has been tampered with or has been corrupted.

Much prior art is devoted to encryption techniques, or to security labeling of objects.

DE 19535019 describes the application of a separate pattern of image or data onto the magnetic strip of a card, by means of magnetic material having a coercivity that differs from the coercivity of the magnetic strip which is already present on the card. This separate pattern is then used in a method of encrypting data on the card.

U.S. Pat. No. 5,975,581 describes a method of confirming the authenticity of an article. A piece of semi-hard material is placed on the object, and “printed” with a magnetic image. This image, invisible to the naked eye, is visualised using a magnetic loop, and compared with an original to confirm authenticity.

U.S. Pat. No. 4,511,616 describes laminated security tags which comprise a base layer, for example paper, a magnetic layer deposited on the base layer, and a vapour deposited metallic layer either over the magnetic layer or the opposite face of the base layer. The laminate provides dual levels of information recording: magnetic encoding of the magnetic layer, and electro-sensitive inscription of the metallic layer. The content of the magnetic layer may be read by a magnetic loop. One form of magnetic loop for visualising magnetic information is described in U.S. Pat. No. 4,345,820.

U.S. Pat. No. 3,858,514 describes a system for visualising magnetic data in which a permanent magnet sheet, typically having a coercive force of 1,400 oersteds, is encoded with Hollerith, ASCII or alphanumeric characters. These characters are read by superimposing the sheet adjacent a transfer sheet and supplying magnetic toner powder to the exposed surface of the transfer sheet, thereby rendering the data visible. The powder may be permanently affixed to the transfer sheet by known powder fixing techniques. The use envisaged is in credit cards.

EP 310707A describes a document, for example a banknote, containing an anti-forgery strip which contains a supporting layer of polyester, on which are deposited spaced magnetic deposits of iron oxide, typically by rotogravure or offset printing, which permits the deposition of varying amounts of oxide. The deposits are positioned in a particular format, for example a bar code, and are covered with a layer of paint. The printed pattern is permanently fixed, and can be read using a magnetic reader.

None of the prior art referred to above provides a solution to the particular problem of testing the integrity of magnetic data applied to a document.

We have now developed a simple and effective verification system, which utilizes the fraud resistant property of magnetic images. Alphanumeric data which has been magnetically written on to sheet products such as described above can be erased, overwritten or altered using magnetic data writing equipment which is fairly readily available. This can provide an opportunity for fraud. Pictorial or graphic magnetic images, though erasable, are less susceptible to fraudulent alteration because the equipment required to produce them is more specialized and less widely available, and unlike alphanumeric characters, images can be created individually rather than being of a standard form. The present invention requires that a pictorial or graphic reference image be magnetically written into a document or similar, in addition to normal alphanumeric data. If an attempt is made to tamper with the alphanumeric data, the magnetic fields used to create alterations will also disturb or corrupt the reference image. Therefore verification merely requires a check that the reference image is unaltered. This can be done using a variety of magnetic means, for example by dusting on “magnetic toner”, i.e. a toner composition formulated to include magnetic particles or pigments (or, in principle, any other particulate magnetic material) or by means of a “magnetic loop”, i.e. a “sandwich” of fine iron oxide particles in a liquid medium between two sealed transparent sheets, for example of glass or clear plastics material.

In either case, the magnetic particles take up a distribution corresponding to the magnetic field of the reference image with which they are brought into proximity. The configuration of the magnetic reference image remaining on the document is thereby revealed, and can be compared with the standard reference image. Conformity indicates the absence of tampering (and also of disturbance based on extraneous magnetic fields to which the document might have been exposed without fraudulent intent). By contrast, a significant disconformity suggests tampering or an attempt at tampering, or else exposure to extraneous fields which have corrupted the data.

It will be understood that in the context of this specification and claims, alphanumeric magnetic data is magnetic data stored in binary code form, for example in ASCII code or the like. Such codes convert computer binary code into a character code, and vice versa. Standard reading and writing equipment for binary code is widely used. In contrast, pictorial or graphic images may only be stored on a magnetic medium in analogue form. The writing of such images requires more specialist equipment, for example using a perpendicular multi-pin writing system, such as that used in the Nipson magnetographic printing systems.

Accordingly, the present invention provides a method of verifying the accuracy or authenticity of alphanumeric magnetic data on a document, wherein:

(a) the configuration of a pictorial or graphic magnetic reference image in the document is made visible by bringing movable particulate magnetic material into proximity therewith such that the particulate magnetic material takes up a distribution corresponding to the magnetic field of the reference image; and

(b) the magnetic image configuration thus revealed is compared with the reference image to identify any significant disconformity suggesting past exposure of the document to a magnetic field capable of altering said magnetic data.

If the reference image is generally intended to be read by an automated process, an analogue bar code (as distinct from a binary bar code which is equivalent to alphanumeric data) is a convenient image. If the reference image is generally intended to be read by the human eye, then a more visually appealing pictorial or graphical image is usually more convenient.

The invention also provides a method of storing alphanumeric magnetic data on a document and subsequently confirming its authenticity, which comprises storing a pictorial or graphic magnetic reference image on the document; writing said alphanumeric magnetic data to the document; making the configuration of said pictorial or graphical magnetic image visible by bringing movable particulate magnetic material into proximity therewith such that the particulate magnetic material takes up a distribution corresponding to the magnetic field of the reference image; and comparing the magnetic image configuration thus revealed with the reference image to identify any significant disconformity suggesting past exposure of the document to a magnetic field capable of altering said magnetic data.

The reference image may be written to the document before or after the data is written to the document, but is preferably written substantially simultaneously. In any event, it is important that the image and the data are written such that the writing of each does not interfere with the writing or reading of the other.

Typical credit card writing systems use a standard inductive writing head in a horizontal system—i.e. the poles of the magnet are on the same side of the substrate and the lines of magnetic flux run parallel to the magnetic substrate surface. Such systems are used to write alphanumeric data. More specialized equipment is required to write images. In the perpendicular pin writing system, the poles of the writing head are placed either side of the magnetic substrate. The key feature of this system is that the flux lines run perpendicular to the magnetic substrate. In the case of the Nipson system, the pins are in an array of 300 per inch. By moving a substrate past an array of such pins and pulsing them on and off, a pattern of magnetized dots in the form of an image can be generated.

It will be appreciated that the magnetic reference image is not initially visible to the naked eye, and therefore that the security afforded by the present invention is covert in nature, i.e. it will not be readily apparent that a security feature is present.

In its simplest form, the invention can be practiced as a manual verification method in which magnetic toner or other particulate magnetic material is dusted on to or otherwise applied to a document to be verified. The magnetic material particles stick to the magnetised areas of the document. A visual check can then be made to establish whether the reference image is both present and uncorrupted. As an alternative to the use of dusted on particulate material or similar, a magnetic loop can be used, as previously described.

As an alternative to manual verification as just described, the document to be verified can be passed through a modified magnetographic developing system which uses magnetic toner. The magnetic toner particles stick to the document only in its magnetised areas so developing the image. The developed toner image can be left unfused, so that the image used for verification can be wiped away and become invisible again, or fused, to provide a permanent image to facilitate comparison with the standard reference image. This comparison and the associated verification step could themselves be automated, rather than manual.

Suitably the document on which the method of the invention is carried out also carries visible information, and is preferably a sheet product with the properties of paper. Suitably the document comprises a layer of magnetic material, said layer being composed of a material such that the required data and/or images can be written, read and erased using conventional equipment. Preferably it is a sheet product containing a magnetic layer comprising magnetically-activatable particles in a binder matrix. Preferably it comprises a pair of laminated outer sheets between which is a magnetic layer comprising magnetically-activatable particles in a binder matrix, the outer sheets having sufficient opacity to mask the appearance of the magnetic layer. The outer sheets are suitably made of natural or synthetic paper. The outer sheets are preferably of paper, although plastic sheet materials which simulate the properties of paper (so-called “synthetic paper”) can alternatively be used. The magnetic layer may be formed by a coating on the inwardly facing surface of one or both of the outer sheets, or may be formulated as a laminating adhesive which is applied as or just before the two outer sheets are brought together in a laminating press or similar equipment. Preferably, at least one outer sheet carries a pigment/binder coat on its inward facing surface so as to enhance the masking effect.

The magnetic layer should be composed of a material such that the required data and/or images can be written, read and erased using conventional equipment. Such equipment in practice requires the use of low-strength magnetic materials. Thus, the coercivity (magnetic strength) of the layer should be suitable for the intended use and should preferably be less than 500 oersteds. Suitably the layer is substantially homogenous, i.e. its coercivity is substantially uniform across its area, and preferably it extends over the whole area of the document, although layers of smaller area than the document may also be used. Suitable magnetic materials include chromium dioxide, iron oxide, polycrystalline nickel-cobalt alloys, cobalt-chromium or cobalt-samarium alloys, or barium-ferrite, although these do not constitute a comprehensive list of suitable materials.

In a further preferred embodiment, the document is part of a so-called “carbonless” or pressure-sensitive copying system. A business forms set using the transfer type of pressure-sensitive copying paper comprises an upper sheet (usually known as a “CB” sheet) coated on its lower surface with microcapsules containing a solution in an oil solvent or solvent composition of at least one chromogenic material and a lower sheet (usually known as a “CF” sheet) coated on its upper surface with a colour developer composition. If more than one copy is required, one or more intermediate sheets (usually known as “CFB” sheets) are provided, each of which is coated on its lower surface with microcapsules and on its upper surface with colour developer composition. In a variant of the above-described arrangement, the solution of chromogenic material may be present as dispersed droplets in a continuous pressure-rupturable matrix instead of being contained within discrete pressure-rupturable microcapsules. In another type of pressure-sensitive copying system usually known as a self-contained or autogenous system, microcapsules and colour developing co-reactant material are coated onto the same surface of a sheet. In a preferred embodiment of the present invention, the document comprises a magnetically-activatable sheet product comprising a pair of laminated outer sheets between which is a magnetic layer comprising magnetically-activatable particles in a binder matrix, the outer sheets having sufficient opacity to mask the appearance of the magnetic layer; at least one of the outer sheets being provided on its outward facing surface with a coating which comprises either microcapsules containing a solution of at least one chromogenic material, or dispersed droplets containing at least one chromogenic material in a pressure-rupturable matrix, or a colour developer composition, or both microcapsules containing at least one chromogenic material and also a colour developer. Because of the nature of the processes in which pressure-sensitive papers are commonly used, the ability of one or more sheets of a set to carry magnetic information as well as visible information is a major advance, since it reduces or eliminates the requirement for human intervention and/or the requirement for retention of data stored, for example on business forms, in physical rather than electronic form. This provides major benefits in terms of paper handling and consequential lowering of costs, in numerous circumstances. The present invention is especially useful in such circumstances, where the opportunity for fraud or for corruption of data is significant.

The invention also extends to a document or other sheet product suitable for verification by a method according to the invention which comprises magnetic material which has a coercivity which is substantially uniform across its area, and which carries a pictorial or graphic magnetic reference image in addition to alphanumeric magnetic data. The invention further extends to a document or other sheet product suitable for verification by a method according to the invention which comprises a pair of laminated outer sheets between which is a magnetic layer comprising magnetically-activatable particles in a binder matrix, the outer sheet having sufficient opacity to mask the appearance of the magnetic layer, and which carries a pictorial or graphic magnetic reference image in addition to alphanumeric magnetic data. Said documents preferably have characteristics as described above.

The invention will now be illustrated by the following Example, in which all parts and percentages are by weight unless otherwise stated.

A 49 g m⁻² strong lightweight base paper of the kind conventionally used in pressure-sensitive copying paper was blade coated on a large-scale pilot plant coater with a 46% solids content aqueous primer coat formulation of the following composition:

| Component | Parts by weight (dry basis) |
|---|---|
| Calcined clay | 100 |
| Oxidised potato starch | 5 |
| Styrene-butadiene latex | 15 |

The coatweight applied was about 9 g m⁻² on a dry basis, and the result was an opaque paper with a flat primer-coated surface.

The primer coated surface was then coated with a 41% solids content aqueous magnetic coating formulation using a small scale pilot plant blade coater. The coatweight applied was about 10 g m⁻² on a dry basis, and the coating formulation was as follows:

| Component | Parts by weight (dry basis) |
|---|---|
| Iron Oxide | 100 |
| Styrene-butadiene latex | 17.6 |

A small-scale pilot coater/laminating press was used to laminate one ply of primer- and magnetic-coated paper as just described to a primer-coated sheet as described above but which did not carry a magnetic coating. The magnetic-coated surface faced inward, so that it formed a magnetic layer between the two paper plies. A 15% solids content aqueous solution of polyvinyl alcohol was used as a laminating adhesive and was continuously rod coated on to the magnetic coating just before the laminating nip. A portion of the resulting product was then magnetically imaged (encoded) with a known bar code at 37.5 bpi (bits per inch) using an inductive magnetic writer of the kind conventionally used for encoding the magnetic strips of credit cards.

The bar code served as a reference image and covert security feature, and could be made visible using a magnetic loop.

The thus encoded sheet was then passed through the writer a second time, but with the writer arranged to write a different bar code. The magnetic loop was again used to make the resulting image on the sheet visible. The thus-visualised image was compared with the original reference image and found to be different, indicating that the sheet had been altered by exposure to a further magnetic field after the original image had been applied.

1. A method of verifying the accuracy or authenticity of alphanumeric magnetic data on a document, wherein:
(a) the configuration of a pictorial or graphic magnetic reference image in the document is made visible by bringing movable particulate magnetic material into proximity therewith such that the particulate magnetic material takes up a distribution corresponding to the magnetic field of the reference image; and
(b) the magnetic image configuration thus revealed is compared with the reference image to identify any significant disconformity suggesting past exposure of the document to a magnetic field capable of altering said magnetic data or images.

2. A method as claimed in claim 1, in which the document also carries visible information.

3. A method as claimed in claim 1, in which the document carries a layer of magnetic material which has a coercivity which is substantially uniform across its area.

4. A method as claimed in claim 1, in which the document comprises a pair of laminated outer sheets between which is a magnetic layer comprising magnetically-activatable particles in a binder matrix, the outer sheet having sufficient opacity to mask the appearance of the magnetic layer.

5. A method as claimed in claim 4, wherein said outer sheets are of natural or synthetic paper.

6. A method as claimed in claim 4, wherein the magnetic layer is formed by a coating on the inwardly facing surface of one or both of the outer sheets, or by a laminating adhesive which is applied as or just before the two outer sheets are brought together in a laminating press or similar equipment.

7. A method as claimed in claim 4, in which at least one outer sheet carries a pigment/binder coat on its inward facing surface.

8. A method as claimed in any one of claims claim 4, at least one of the outer sheets being provided on its outward facing surface with a coating which comprises either microcapsules containing a solution of at least one chromogenic material, or dispersed droplets containing at least one chromogenic material in a pressure-rupturable matrix, or a colour developer composition, or both microcapsules containing at least one chromogenic material and also a colour developer.

9. A method of storing alphanumeric magnetic data on a document and subsequently confirming its authenticity, which comprises storing a pictorial or graphic magnetic reference image on the document; writing said alphanumeric magnetic data to the document; and subsequently verifying the accuracy or authenticity of said alphanumeric magnetic data by a method as claimed in claim 1.

10. A document or other sheet product suitable for verification by a method as claimed in claim 1 which comprises magnetic material which has a coercivity which is substantially uniform across its area, and which carries a pictorial or graphic magnetic reference image in addition to alphanumeric magnetic data.

11. A document or other sheet product suitable for verification by a method as claimed in claim 1 which comprises a pair of laminated outer sheets between which is a magnetic layer comprising magnetically-activatable particles in a binder matrix, the outer sheet having sufficient opacity to mask the appearance of the magnetic layer, and which carries a pictorial or graphic magnetic reference image in addition to alphanumeric magnetic data.

12. (canceled)
